(19) United States
(12) Patent Application Publication
(10) Pub. No.: US 2013/0214917 A1
(43) Pub. Date: Aug. 22, 2013

(54) METHOD AND SYSTEM FOR PROVIDING A VEHICLE THEFT PREVENTION SERVICE

(71) Applicants: Tae Yun Chung, Gangneung-si (KR); Pan Jong Park, Gangneung-si (KR); Chang Yeong Choi, Gangneung-si (KR)

(72) Inventors: Tae Yun Chung, Gangneung-si (KR); Pan Jong Park, Gangneung-si (KR); Chang Yeong Choi, Gangneung-si (KR)

(73) Assignee: GANGNEUNG-WONJU NATIONAL UNIVERSITY INDUSTRIAL ACADEMY COOPERATION GROUP, Gangneung-si (KR)

(21) Appl. No.: 13/882,757

(22) PCT Filed: Aug. 31, 2011
(86) PCT No.: PCT/KR11/06439

§ 371 Date: May 1, 2013

(30) Foreign Application Priority Data
Nov. 3, 2010 (KR) 10-2010-0108746
May 23, 2011 (KR) 10-2011-0048343

(51) Int. Cl. B60R 25/10

(52) U.S. Cl. CPC B60R 25/1004
USPC 340/426.19; 340/426.18

(57) ABSTRACT

A vehicle theft prevention service method and system is capable of estimating theft of a vehicle even in the case where such a two-wheeled vehicle can be moved without start-up to be stolen and a vehicle theft prevention service method and system where a user is informed of location of a vehicle at the time of estimating theft of the vehicle, so that it is possible to accurately determine the theft based on the location of the vehicle at the time of estimating the theft of the vehicle. The vehicle theft prevention service system includes an electronic key and a theft monitoring device. The theft monitoring device is installed in a vehicle and determines that the vehicle is in a theft-estimated state and transmits an alarm message if a sensed acceleration value obtained by sensing a movement of the vehicle is a predetermined value or more. The electronic key outputs an alarm if the alarm message is received. Herein, the external apparatus may be a user terminal or a server.

### TECHNICAL FIELD

The present invention relates to a vehicle, and more particularly, to a vehicle theft prevention service method and system which estimates theft of a vehicle through a theft monitoring device installed in the vehicle, notifies a theft-estimated state to a user, and tracks location of the vehicle or reports theft according to user's request.

### BACKGROUND ART

With development of technologies, various types of auxiliary devices are attached to a vehicle. For example, a rear object access detection apparatus, a distance sensor, a car navigation system (CNS), an anti-lock brake system (ABS), a theft prevention apparatus, and the like are attached thereto.

As an example of the theft prevention apparatus, Korean Patent Application No. 10-2001-0018953 discloses a technique for preventing an intruder from intruding a vehicle and alarms the intrusion.

The technique disclosed in Patent Document is a vehicle theft prevention system configured to include a sensing unit which senses an attempt of theft of a vehicle; a theft prevention mode conversion unit which blocks start-up of the vehicle and converts into a theft prevention mode if the attempt of theft is sensed; a theft prevention mode release unit which releases the theft prevention mode; and an urgent theft prevention mode conversion/release unit which allows a prompt treatment to be performed in an urgent situation.

However, in the above-described vehicle theft prevention system, the theft is prevented by blocking the start-up of the vehicle only if the attempt of theft is sensed. Therefore, in the case where such a two-wheeled vehicle can be moved without start-up to be stolen, there is a problem in that the vehicle theft prevention system cannot be applied thereto.

In addition, the attempt of theft of the vehicle is sensed based on the operation of a start-up key and the operation of a brake, an accelerator, a clutch, and the like. Therefore, in the case where such a two-wheeled vehicle can be moved without start-up to be stolen, there is a problem in that the vehicle theft prevention system cannot be applied thereto.

In addition, in the vehicle theft prevention system where the start-up of vehicle is blocked if the attempt of theft is sensed, in the case where theft is mistakenly sensed during the driving, the engine may stop working, so that accident may occur.

### DISCLOSURE

### Technical Problem

The present invention is to provide a vehicle theft prevention service method and system capable of estimating theft of a vehicle even in the case where such a two-wheeled vehicle can be moved without start-up to be stolen.

The present invention is also to provide a vehicle theft prevention service method and system where a user is informed of location of a vehicle at the time of estimating theft of the vehicle, so that it is possible to accurately determine the theft based on the location of the vehicle at the time of estimating the theft of the vehicle.

The present invention is also to provide a vehicle theft prevention service method and system where a theft reporting message which is received when a vehicle is determined to be stolen is transmitted to a related official system such as a police system, so that is possible to prevent unnecessary theft reporting in a theft-estimated state from being received by the police system.

### Technical Solution

According to an aspect of the prevent invention, there is provided a vehicle theft prevention service system including a theft monitoring device and an electronic key. The theft monitoring device is installed in a vehicle and determines that the vehicle is in a theft-estimated state and transmits an alarm message if a sensed acceleration value obtained by sensing a movement of the vehicle is a predetermined value or more. The electronic key outputs an alarm if the alarm message is received.

According to another aspect of the prevent invention, there is provided a vehicle theft prevention service method including steps of: allowing a theft monitoring device which is installed in a vehicle to determine that the vehicle is in a theft-estimated state if a sensed acceleration value obtained by sensing a movement of the vehicle is a predetermined value or more; and allowing the theft monitoring device to transmit an alarm message to an electronic key or an external apparatus.

### Advantageous Effects

According to the present invention, it is possible to sense theft of a vehicle such as a two-wheeled vehicle which can be moved without start-up to be stolen.

In addition, according to the present invention, a user is informed of location of a vehicle at the time of estimating theft of the vehicle, so that it is possible to accurately determine the theft based on the location of the vehicle at the time of estimating the theft of the vehicle.

In addition, according to the present invention, a theft reporting message which is received when a vehicle is determined to be stolen is transmitted to a related official system such as a police system, so that is possible to prevent unnecessary theft reporting in a theft-estimated state from being received by the police system.

### BRIEF DESCRIPTION OF DRAWINGS

FIG. 1 is a diagram illustrating a configuration of a vehicle theft prevention service system according to an exemplary embodiment of the present invention.

FIG. 2 is a diagram illustrating a configuration of a theft monitoring device illustrated in FIG. 1.

FIG. 3 is a diagram illustrating a configuration of an electronic key illustrated in FIG. 1.

FIGS. 4 to 8 are diagrams illustrating a flowchart of a vehicle theft prevention service method according to another exemplary embodiment of the present invention.

### BEST MODE

According to the present invention, even in the case of a vehicle such as a motor bicycle which may be moved to be stolen without startup thereof, theft of the vehicle can be sensed.

In addition, according to the present invention, at the time of estimating theft of a vehicle, a user is informed of a location of the vehicle, so that theft can be accurately determined based on a change in location of the vehicle.

In addition, according to the present invention, when the vehicle is determined to be stolen and a theft reporting message is received, the theft reporting message is transmitted to a related official system such as a police system, so that it is possible to prevent unnecessary theft reporting in a theft-estimated state from being received by the police system.

<Vehicle Theft Prevention Service System>

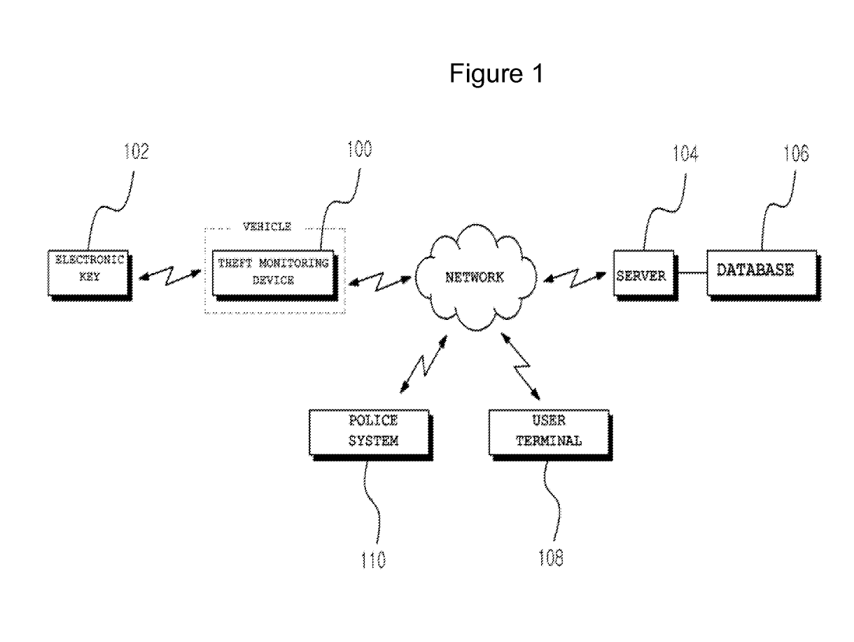

A configuration of a vehicle theft prevention service system according to an exemplary embodiment of the present invention will be described in detail with reference to FIG. 1.

The vehicle theft prevention service system is configured to include a theft monitoring device 100, an electronic key 102, a server 104, and a database 106.

In a theft monitoring mode, the theft monitoring device 100 determines whether or not the vehicle is in a theft-estimated state, based on whether or not abnormal start-up is notified from a vehicle control unit which is installed in the vehicle to control components of the vehicle, whether or not a distance from the electronic key 102 is larger than a predetermined distance, or whether or not a sensed acceleration value is a predetermined value or more. In the case where it is determined that the vehicle is in the theft-estimated state, the theft monitoring device 100 transmits a theft estimation alarm informing message to the electronic key 102 or an external apparatus. Herein, the external apparatus may be a user terminal 108 or the server 104.

When the theft monitoring device 100 receives a theft-estimated state release message from the electronic key 102 or the user terminal 108 which receives the theft estimation alarm informing message, the theft monitoring device 100 releases the theft-estimated state or notifies a theft-estimated state release informing message to the user terminal 108 or the electronic key 102.

In addition, if the server 104 requests location information in response to the request of the user terminal 108 receiving the theft estimation alarm informing message, the theft monitoring device 100 transmits GPS-based location information to the server 104. Particularly, in the theft-estimated state, the theft monitoring device 100 transmits the location information to the server 104 at a predetermined period, so that the server 104 can be allowed to track a moving path of the vehicle.

The electronic key 102 receives a location checking request message, which the theft monitoring device 100 transmits at a predetermined period in a theft monitoring mode, and transmits a location checking response message. Herein, the theft monitoring device 100 estimates a distance from the electronic key 102 based on a time difference between a transmission time point of the location checking request message and a reception time point of the location checking response message.

In addition, when the electronic key 102 receives the theft estimation alarm informing message from the theft monitoring device 100, the electronic key 102 outputs the theft estimation alarm informing message to alarm a vehicle's owner carrying the electronic key 102.

If the vehicle's owner commands release of the theft-estimated state according to the alarm, the electronic key 102 transmits a theft-estimated state release message to the theft monitoring device 100.

Next, if the server 104 receives the theft estimation alarm informing message from the theft monitoring device 100, the server 104 stores the theft estimation alarm informing message in a vehicle information storage area, which is allocated in advance so as to correspond to theft monitoring device identification information included in the theft estimation alarm informing message, and transmits the theft estimation alarm informing message to the user terminal identified by the user terminal identification information which is stored in advance in the vehicle information storage area.

In addition, if the server 104 receives the theft-estimated state release informing message from the theft monitoring device 100, the server 104 stores the theft-estimated state release informing message in a vehicle information storage area, which is allocated in advance so as to correspond to theft monitoring device identification information included in the theft-estimated state release informing message, and transmits the theft-estimated state release informing message to the user terminal identified by the user terminal identification information which is stored in advance in the vehicle information storage area.

In addition, when the server 104 receives the location tracking request message from the user terminal 108, the server 104 transmits a location information request message to the theft monitoring device 100 and stores the location information provided by the the theft monitoring device 100 in the vehicle information storage area which is allocated so as to correspond to the theft monitoring device identification information. Herein, the the server 104 may sequentially stores the location information which is periodically transmitted by the theft monitoring device 100 and may track the moving path of the vehicle.

In addition, when the server 104 receives the theft-estimated state release message from the user terminal 108, the server 104 stores the theft-estimated state release informing message in the vehicle information storage area corresponding to the user terminal identification information and transmits the theft-estimated state release informing message to the theft monitoring device 100 identified by the theft monitoring device identification information which is stored in advance in the the vehicle information storage area.

When theft reporting is requested through the user terminal 108 or the electronic key 102, the server 104 notifies the theft reporting message and information on the current location or the moving path of the vehicle to the police system 110.

The database 106 includes a vehicle information storage area corresponding to the theft monitoring device identification information. The the vehicle information storage area is allocated at the time of registering the theft monitoring device. Theft monitoring device identification information, a vehicle serial number, user terminal identification information, and information on a normal state, a theft-estimated state, theft-estimated state release, location information, and the like are stored in the vehicle information storage area.

<Theft Monitoring Device >

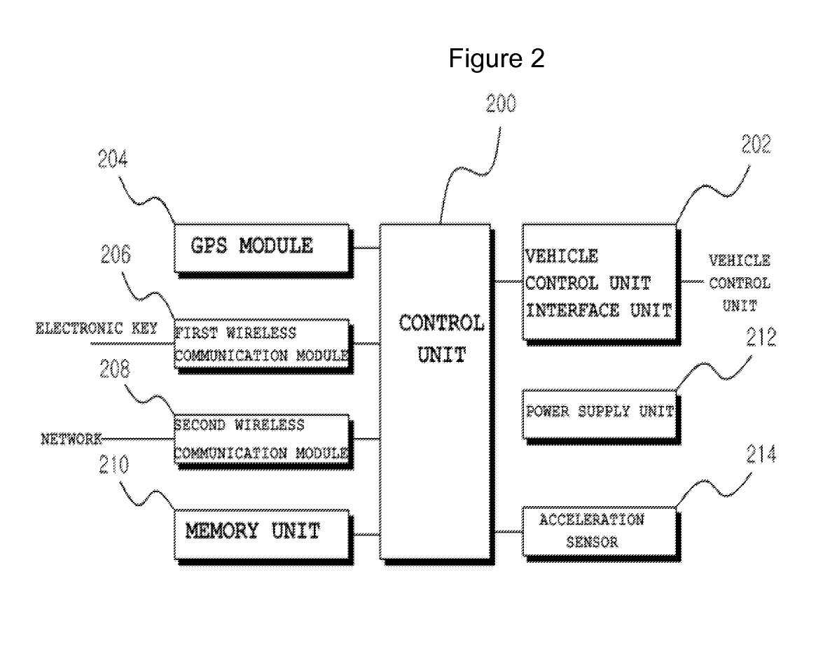

A configuration and operations of the theft monitoring device 100 according to the exemplary embodiment of the present invention will be described with reference to FIG. 2.

The theft monitoring device 100 is configured to include a control unit 200, a vehicle control unit interface unit 202, a GPS module 204, a first wireless communication module 206, a second wireless communication module 208, a memory unit 210, a power supply unit 212, and an acceleration sensor 214.

The control unit 200 controls the whole components of the theft monitoring device 100 and performs a vehicle theft monitoring function according to the exemplary embodiment of the present invention.

In other words, if a vehicle control unit notifies abnormal start-up through the vehicle control unit interface unit 202, if a distance from the electronic key 102 is a predetermined distance or more, or if a sensed acceleration value is a predetermined value or more, the control unit 200 determines that the vehicle is in a theft-estimated state and notifies a theft estimation alarm message to the electronic key 102 or the server 104.

In addition, when the control unit 200 receives the theft-estimated state release message from the electronic key 102, the control unit 200 releases the theft-estimated state and notifies the theft-estimated state release to the server 104.

In addition, when the control unit 200 receives the theft-estimated state release message from the server 104, the control unit 200 releases the theft-estimated state and notifies the theft-estimated state release to the electronic key 102.

In addition, when the control unit 200 receives the location information request message from the server 104, the control unit 200 transmits location information, which is provided from the GPS module 204, to the server 104. The transmission of the location information is periodically performed until the theft-estimated state is released.

The vehicle control unit interface unit 202 functions as an interface between the vehicle control unit and the control unit 200.

The GPS module 204 receives information from a GPS satellite, detects location information on the current location, and provides the location information to the control unit 200.

The first wireless communication module 206 performs wireless communication between the electronic key 102 and the control unit 200.

The second wireless communication module 208 performs wireless communication between the server 104 and the control unit 200 via network.

The memory unit 210 stores a variety of information including process programs of the control unit 200 and theft monitoring device identification information according to an exemplary embodiment of the present invention.

The power supply unit 212 supplies driving power to components of the theft monitoring device 100 and electrically charges vehicle power output from a vehicle power output terminal.

The acceleration sensor 214 provides a sensed acceleration value indicating a movement of the theft monitoring device 100 to the control unit 200.

<Electronic Key>

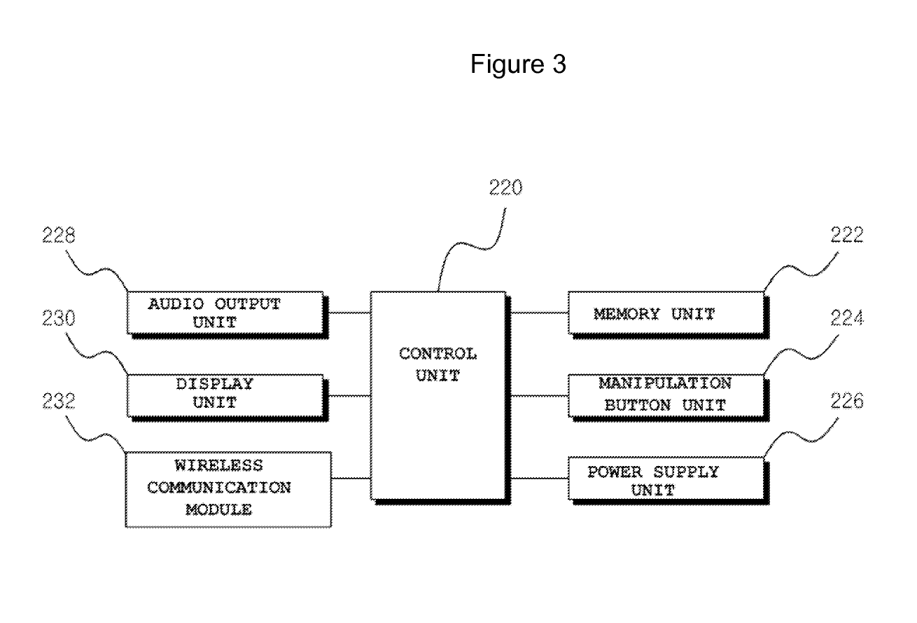

A configuration of the electronic key 102 according to the exemplary embodiment of the present invention will be described in detail with reference to FIG. 3.

The electronic key 102 is configured to include a control unit 220, a memory unit 222, a manipulation button unit 224, a power supply unit 226, an audio output unit 228, a display unit 230, and a wireless communication module 232.

The control unit 220 controls the whole components of the electronic key 102. When a theft-estimated state informing message is received according to the exemplary embodiment of the present invention, the control unit 220 outputs an alarm sound or blinks an alarm light to inform the user of the theft-estimated state. When the user inputs information indicating command of theft-estimated state release through a manipulation button unit 224, the control unit 220 transmits a theft-estimated state release message to the theft monitoring device 100.

The memory unit 222 stores a variety of information including a process program of the control unit 220.

The manipulation button unit 224 includes a plurality of buttons. Particularly, the manipulation button unit 224 includes buttons for commanding the theft-estimated state release according to the exemplary embodiment of the present invention.

The power supply unit 226 supplies driving power to components of the electronic key 102.

The audio output unit 228 output an alarm sound or the like under the control of the the control unit 220.

The display unit 230 is an LED array or a small-sized display apparatus. The display unit 230 outputs alarm light or theft-estimated state informing light under the control of the control unit 220.

The wireless communication module 232 performs communication between the theft monitoring device 100 and the control unit 220.

<Vehicle Theft Monitoring Method>

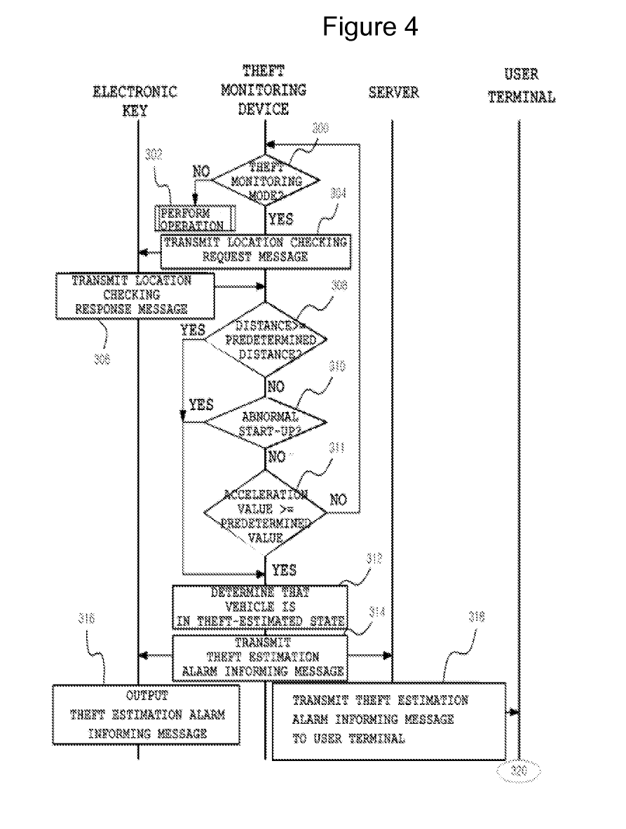

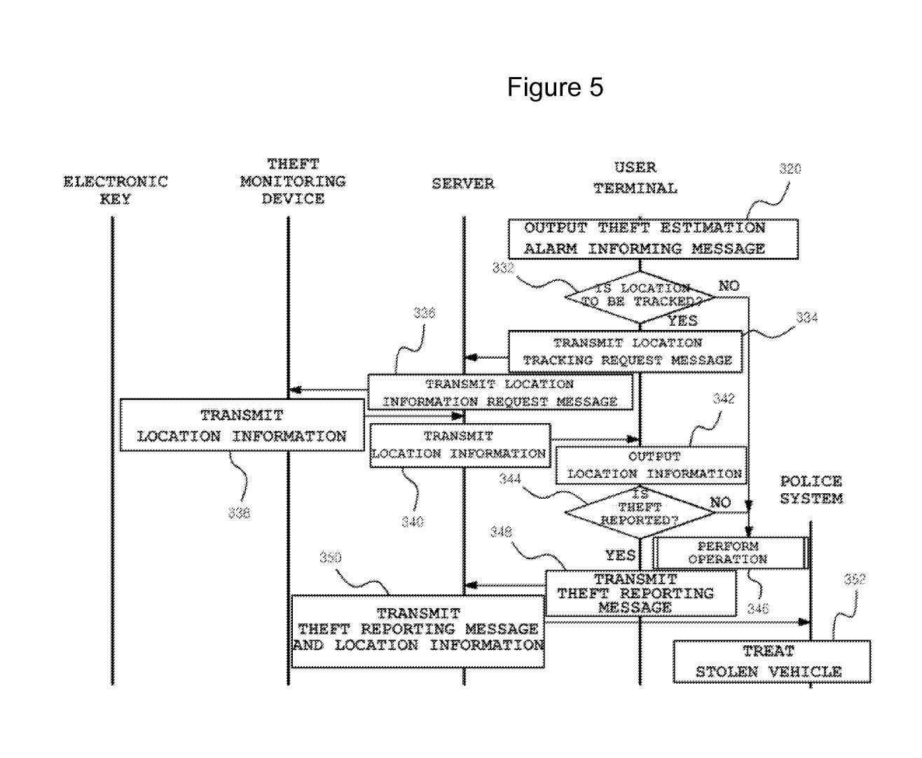

A vehicle theft monitoring method which can be adapted to the above-described vehicle theft prevention service system will be described in detail with reference to FIGS. 4 to 6.

First, in order to use a vehicle theft prevention service, a user purchases and installs the theft monitoring device 100. Next, the user accesses the server 104 which is managed by a service provider company to make a purchase registration of the theft monitoring device 100. At the time of the purchase registration, the server 104 allocates a vehicle information storage area corresponding to the theft monitoring device identification information of the theft monitoring device to the database 106. The server 104 stores the theft monitoring device identification information, the user terminal identification information, the location information, the vehicle serial number, and the like in the vehicle information storage area.

In addition, in order to check an operation state of the theft monitoring device 100, the server 104 transmits a location information request message to the theft monitoring device 100. The server 104 receives location information, which is transmitted by the theft monitoring device 100 according to the the location information request message, and informs the user terminal 108 of the location information. If the informed location information is coincident with actual information, the user determines that the operation state is normal.

After the above-described initial purchase registration is finished, the theft monitoring device 100 proceeds to a theft monitoring mode according to a predetermined event such as user's request or start-up (Step S300).

In the theft monitoring mode, the theft monitoring device 100 transmits a location checking request message to the electronic key 102 (Step S304). The electronic key 102 receiving the location checking request message transmits the location checking response message to the theft monitoring device 100 (Step S306).

The the theft monitoring device 100 detects a time interval between the time when the location checking request message is transmitted and the time when the the location checking response message is received and detects a distance from the electronic key 102 based on the time interval. When the distance from the electronic key 102 is a predetermined distance or more, the theft monitoring device 100 determines that the vehicle is in the theft-estimated state (Step S308).

In addition, when the abnormal start-up is notified from the vehicle control unit interface unit 202, the theft monitoring device 100 determines that the vehicle is in the theft-estimated state (Step S310).

In addition, when the acceleration sensor 214 provides a sensing value of a predetermined value or more, the theft monitoring device 100 determines that the vehicle is in the theft-estimated state (Step S311).

When it is determined that the vehicle is in the theft-estimated state, the theft monitoring device 100 transmits a theft estimation alarm informing message to the electronic key 102 and the server 104 (Step S314).

The electronic key 102 receiving the theft estimation alarm informing message outputs an alarm sound, blinks an alarm light, or displays an alarm informing message according to the theft estimation alarm informing message to inform the user of the theft-estimated state (Step S316).

In addition, the server 104 receiving the theft estimation alarm informing message stores the theft estimation alarm informing message in the vehicle information storage area corresponding to the theft monitoring device identification information included in the theft estimation alarm informing message, reads the user terminal identification information stored in the vehicle information storage area, and transmits the theft estimation alarm informing message to the user terminal 108 identified by the user terminal identification information (Step S320). When the user terminal 108 receives the theft estimation alarm informing message, the user terminal 108 displays the theft estimation alarm informing message to inform the user of the theft-estimated state. Herein, the sever 104 continues to transmit the theft estimation alarm message in an audio or text form to the user terminal 108 until the user checks the theft estimation alarm informing message and transmits the location tracking request message or the theft-estimated state release message.

If the user checks the theft estimation alarm informing message and commands location tracking, the user terminal 108 transmits a location tracking request message to the server 104.

When the server 104 receives the location tracking request message, the server 204 transmits a location information request message to the theft monitoring device 100 identified by the theft monitoring device identification information which is registered so as to correspond to the user terminal identification information.

When the theft monitoring device 100 receives, the location information request message, the theft monitoring device 100 transmits location information on the current location thereof to the server 104.

The server 104 stores the location information in the database 106 and transmits the location information to the user terminal 108.

The user terminal 108 displays the location according to the the location information on a map, so that the user can be allowed to find the location of the vehicle by intuition (Step S342).

The user whom is informed of the location of the vehicle may also command theft reporting through the user terminal 108.

When the user commands the theft reporting, the user terminal 108 generates a theft reporting message to the server 104 (Steps 5344 and S348).

When the server 104 receives the theft reporting message, the server 104 generates a theft reporting message including a vehicle serial number stored in the vehicle information storage area corresponding to the user terminal identification information and the location information and transmits the theft reporting message to a police system 110 (Step S350).

The police system 110 performs a process of tracking the stolen vehicle according to the theft reporting message (Step S352).

On the other hand, in the case where the theft-estimated state is not an actually-stolen state, the theft-estimated state release needs to be performed. The theft-estimated state release may be performed by the electronic key 102 and the user terminal 108.

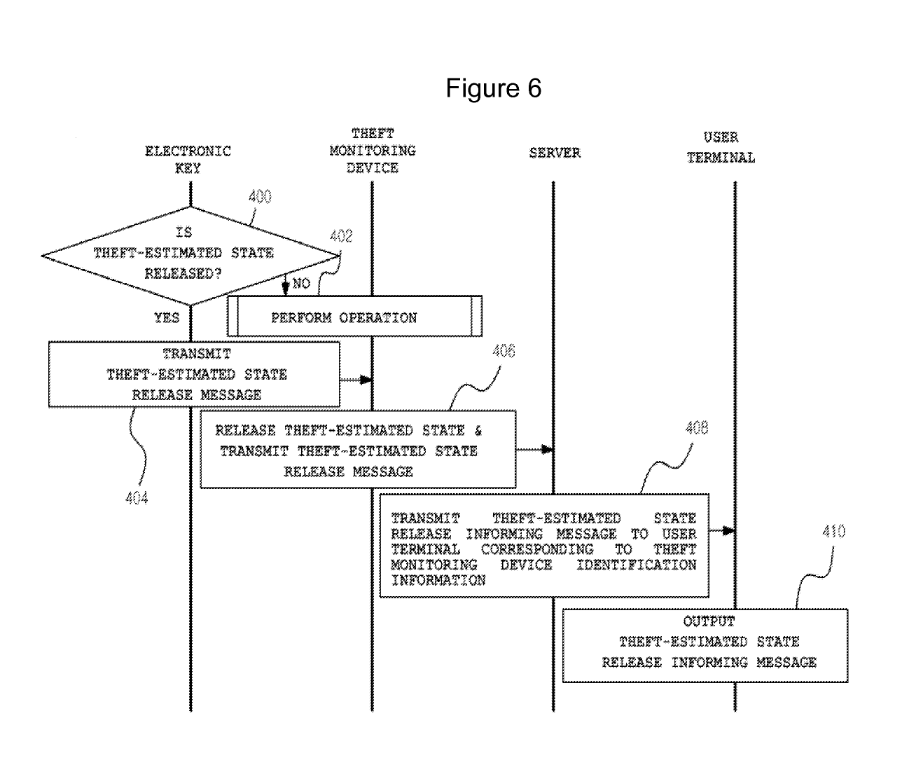

Referring to FIG. 6, after the electronic key is informed on the theft-estimated state, the electronic key 102 checks whether or not the the user pushes a button of the manipulation button unit to command theft-estimated state release (Step S400). If the user pushes the button of the manipulation button unit to command the theft-estimated state release, the electronic key 102 transmits a theft-estimated state release message to the the theft monitoring device 100 (Step S402). When the theft monitoring device 100 receives the theft-estimated state release message, the theft monitoring device 100 releases theft-estimated state and notifies a theft-estimated state release message to the server 104 (Step S406).

The server 104 stores the theft-estimated state release message in the vehicle information storage area corresponding to the theft monitoring device identification information and transmits the theft-estimated state release informing message to the user terminal 108 identified by the user terminal identification information corresponding to the theft monitoring device identification information (Step S408).

The user terminal 108 receiving the theft-estimated state release informing message informs the user of the theft-estimated state release (Step S410).

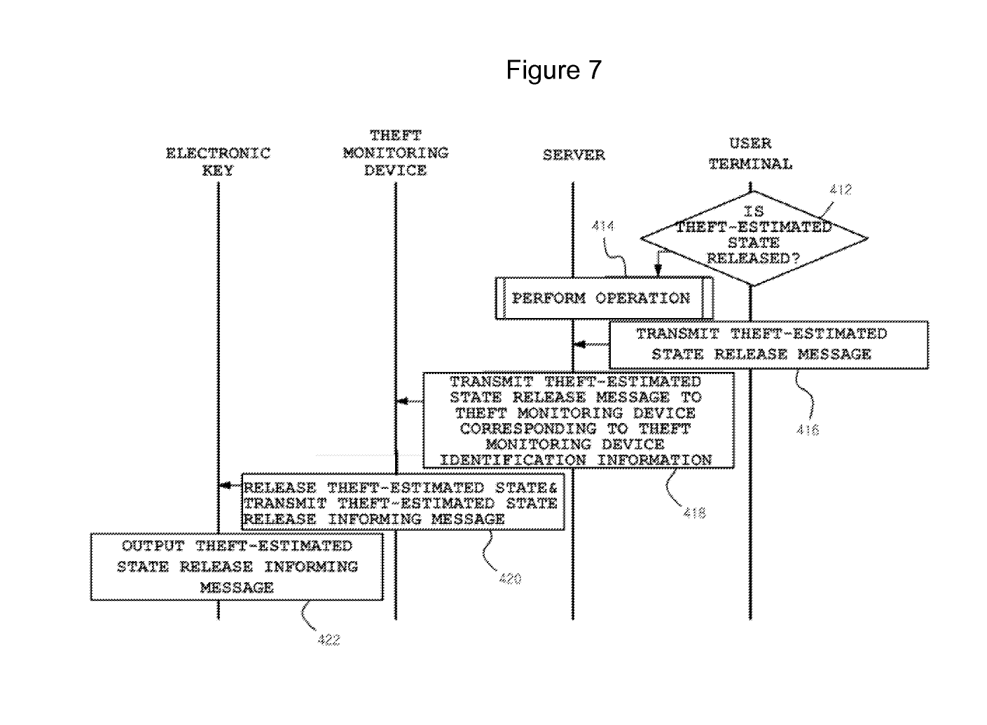

Referring to FIG. 7, after the user terminal is informed on the theft-estimated state, the user terminal 108 checks whether or not the user commands the theft-estimated state release (Step S412). If the theft-estimated state release is commanded by the user, the user terminal 108 transmits a theft-estimated state release message to the server 104 (Step S416). The server 104 stores the theft-estimated state release message in a vehicle information storage area corresponding to the theft monitoring device identification information and transmits the theft-estimated state release message to the theft monitoring device corresponding to the theft monitoring device identification information (Step S418). When the theft monitoring device 100 receives the theft-estimated state release message, the theft monitoring device 100 releases the theft-estimated state and notifies the theft-estimated state release informing message to the electronic key 102 (Step S420). When the electronic key 102 receives the theft-estimated state release message, the electronic key 102 informs the user of the theft-estimated state release by outputting an alarm sound, blinking an alarm light, or display an alarm informing message (Step S422).

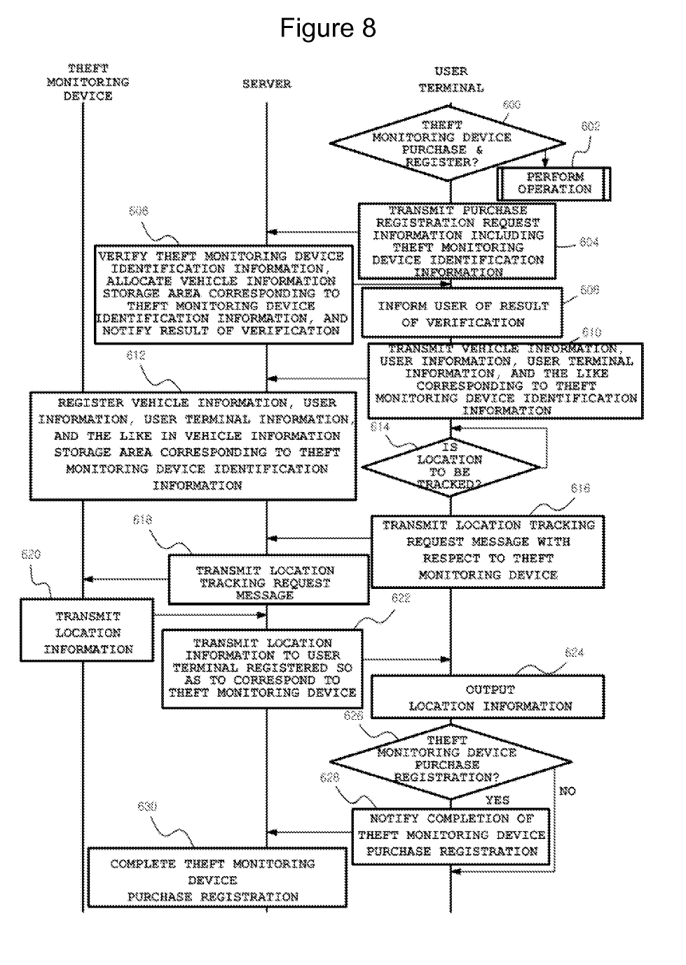

A procedure of purchasing and registering the above-described theft monitoring device 100 will be described with reference to a flowchart illustrated in FIG. 8.

The user who purchase the theft monitoring device 100 accesses the server 104 through the user terminal 108 and requests for theft monitoring device registration (Step S600). In this case, the user terminal 108 is input with the theft monitoring device identification information of the theft monitoring device 100 by the user, and the user terminal 108 transmits purchase registration request information including the theft monitoring device identification information to the server 104 (Step S604).

The server 104 verifies whether or not the theft monitoring device identification information included in the purchase registration request information is normal. If the server 104 succeeds in the verification, the server 104 allocates a vehicle information storage area corresponding to the theft monitoring device identification information to the database 106 and notifies a result of the verification to the user terminal 108 (Step S606).

The user terminal 108 receives the result of the verification corresponding to the theft monitoring device identification information and displays the result of the verification to inform the user of the result of the verification (Step S608).

After the user is informed of the result of the verification, the user inputs vehicle information and user information, corresponding to the theft monitoring device identification information, the user terminal information, and the like to the user terminal 108. The user terminal 108 transmits the vehicle information and the user information corresponding to the theft monitoring device identification information, the user terminal information, and the like to the server 104 (Step S610).

The server 104 stores the vehicle information and the user information corresponding to the theft monitoring device identification information, the user terminal information, and the like in a storage area allocated according to the theft monitoring device identification information (Step S612).

As described above, after the information corresponding to theft monitoring device identification information is transmitted to the server 104 to be registered in the the server 104, the user can verify by using the user terminal 108 whether or not the theft monitoring device normally operates. In this case, the user transmits the location tracking request message including the theft monitoring device identification information to the server 104 through the user terminal 108 (Steps 5614 and S616).

The server 104 receiving the location tracking request message transmits the location tracking request message to the theft monitoring device corresponding to theft monitoring device identification information (Step S618). The theft monitoring device 100 receiving the location tracking request message transmits the location information thereof to the the server 104 (Step S620).

The server 104 stores the location information received from the theft monitoring device 100 in the vehicle information storage area corresponding to the theft monitoring device identification information, reads the user terminal information stored in the vehicle information storage area, and transmits the location information to a user terminal according to the user terminal information (Step S622).

The user terminal receiving the location information outputs the location information to inform the user of the location information (Step S624). If the location information of which the user is informed is coincident with the actual location information, the user notifies completion of the purchase registration of the theft monitoring device 100 to the server 104 (Steps 5626 and 628).

If the completion of the purchase registration of the theft monitoring device is notified to the server 104, the server 104 completes the purchase registration of the theft monitoring device 100 and ends the entire procedure (Step S630).

In the above-described exemplary embodiment of the present invention, the case where the theft monitoring device communicates with the user terminal and the related official system such as a police system through the server is exemplified, but it is obvious that the theft monitoring device can directly communicate with the user terminal or the police system via a network. Particularly, in this case, the theft monitoring device may directly transmit the theft estimation alarm informing message and the location information to the user terminal and directly transmit the theft reporting message to the related official system. In addition, the user terminal may also directly the theft-estimated state release message, the location tracking request message, or the theft reporting message to the theft monitoring device.

1. A vehicle theft prevention service system comprising:
a theft monitoring device which is installed in a vehicle and which determines that the vehicle is in a theft-estimated state and transmits an alarm message if a sensed acceleration value obtained by sensing a movement of the vehicle is a predetermined value or more; and
an electronic key which outputs an alarm if the alarm message is received from the theft monitoring device.

2. The vehicle theft prevention service system according to claim 1,
wherein the theft monitoring device detects a distance from the electronic key, and
wherein the theft monitoring device determines that the vehicle is in the theft-estimated state and transmits the alarm message to the electronic key or an external apparatus if the distance is a predetermined distance or more or if abnormal start-up is notified from a vehicle control unit.

3. The vehicle theft prevention service system according to claim 1, further comprising a user terminal,
wherein the user terminal outputs the alarm message if the alarm message is received from the theft monitoring device.

4. The vehicle theft prevention service system according to claim 1, further comprising:
a user terminal; and
a server which communicates with the user terminal,
wherein the server transmits the alarm message to the user terminal which is set in advance so as to correspond to the the theft monitoring device if the alarm message is received from the theft monitoring device, and
wherein the user terminal outputs the alarm message if the alarm message is received from the server.

5. The vehicle theft prevention service system according to claim 3,
wherein the theft monitoring device includes a location information detection module which detects location information, and
wherein the theft monitoring device provides the location information to the user terminal, and
wherein the user terminal outputs the received location information.

6. The vehicle theft prevention service system according to claim 4,
wherein the theft monitoring device includes a location information detection module which detects location information,
wherein the theft monitoring device transmits the location information to the server,
wherein the server transmits the location information to the user terminal which is set in advance so as to correspond to the theft monitoring device, and
wherein the user terminal outputs the location information.

7. The vehicle theft prevention service system according to claim 5, wherein the user terminal displays the location information on a map.

8. The vehicle theft prevention service system according to claim 1, wherein, if a theft-estimated state release message is received from the electronic key or an external apparatus, the theft monitoring device releases the theft-estimated state and transmits a message informing the electronic key or the external apparatus of the theft-estimated state release.

9. The vehicle theft prevention service system according to claim 1, wherein, if a theft reporting message is received from the electronic key or an external apparatus, the theft monitoring device transmits the theft reporting message to a predetermined-related official system.

10. The vehicle theft prevention service system according to claim 4, wherein, if a theft reporting message is received from the user terminal, the server transmits the theft reporting message to a predetermined official system.

11. A vehicle theft prevention service method comprising steps of:
allowing a theft monitoring device which is installed in a vehicle to determine that the vehicle is in a theft-estimated state if a sensed acceleration value obtained by sensing a movement of the vehicle is a predetermined value or more; and
allowing the theft monitoring device to transmit an alarm message to an electronic key or an external apparatus.

12. The vehicle theft prevention service method according to claim 11,
wherein the step of determining that the vehicle is in a theft-estimated state includes a step of allowing the theft monitoring device to detect a distance from the electronic key and determine that the vehicle is in the theft-estimated state if the distance is a predetermined distance or more or if abnormal start-up is notified from a vehicle control unit.

13. The vehicle theft prevention service method according to claim 11, further comprising, after the step of transmitting an alarm message, a step of allowing a user terminal which receives the alarm message from the theft monitoring device to output the alarm message.

14. The vehicle theft prevention service method according to claim 11, further comprising, after the transmitting, steps of:
allowing a server which receives the alarm message from the theft monitoring device to output the alarm message to a user terminal which is set in advance so as to correspond to the theft monitoring device; and
allowing the user terminal which receives the alarm message from the server to output the alarm message.

15. The vehicle theft prevention service method according to claim 13, further comprising, after the step of transmitting, steps of:
allowing the theft monitoring device to generate location information and transmit the location information to the user terminal; and
allowing the user terminal to output the location information.

16. The vehicle theft prevention service method according to claim 14, further comprising, after the step of transmitting, steps of:
allowing the theft monitoring device to generate location information and transmit the location information to the server;
allowing the server to transmit the location information to a user terminal which is set in advance so as to correspond to the theft monitoring device; and
allowing the user terminal to output the location information.

17. The vehicle theft prevention service method according to claim 15, wherein, in the outputting the location information, the user terminal displays the location information on a map.

18. The vehicle theft prevention service method according to claim 11, further comprising, after the step of transmitting, a step of allowing the theft monitoring device to release the theft-estimated state and transmit a message informing the the electronic key or an external apparatus of the theft-estimated state release if a theft-estimated state release message is received from the electronic key or the external apparatus.

19. The vehicle theft prevention service method according to claim 11, further comprising, after the step of transmitting, a step of allowing the theft monitoring device to transmit the theft reporting message to the predetermined official system if a theft reporting message is received from the electronic key or an external apparatus.

20. The vehicle theft prevention service method according to claim 14, further comprising, after the outputting the alarm message, a step of allowing the server to transmit the theft reporting message to the predetermined-related official system if a theft reporting message is received from the user terminal.
